(19) United States
(12) Patent Application Publication
(10) Pub. No.: US 2010/0046493 A1
(43) Pub. Date: Feb. 25, 2010

(54) Spectrum-Sensing Broadband Modem/Router

(76) Inventor: Nathan Parker, Hot Springs, AR (US)

Correspondence Address: Mallard Computer, Inc.;Nathan Parker, President/CEO, 115 Wild Flower Trail, Demorest, GA, 30535, US

(21) Appl. No.: 12/197,180

(22) Filed: Aug. 22, 2008

(51) Int. Cl. H04J 1/00

(52) U.S. Cl. 370/343

(57) ABSTRACT

This modem would take advantage of the spectrum-sensing and over-the-air television airwaves technology that could become available due to the possibility of the FCC cleaning up the “white spaces” in the television airwaves to answer the petitions of the corporations involved in a coalition to get the FCC to grant this request. With these airwaves available and this device in place, wireless broadband could successfully be available and affordable to customers just about anywhere.

### RELATED APPLICATION

The present application is related to application Ser. No. 111856,472, filed on Apr. 3, 2008, entitled “Spectrum-Sensing Algorithms and Methods.”

### FIELD OF INVENTION

The invention relates to the field of wireless broadband communications and more precisely broadband over television airwaves and spectrum-sensing technology.

### BACKGROUND OF INVENTION

Recently, a coalition of computer/information technology corporations has been formed and has petitioned the Federal Communications Commission (FCC) to free up the “white space” (the unused space in the television spectrum) in the television airwaves. Google, one of the coalition members, proposed to the FCC that “spectrum-sensing” may be used in modems connected to the airwaves to efficiently receive a signal. As of now, no proposed modems appear to be patented, nor have the ideas for them bee formulated by any of the coalition members at this time. Parker, will present this device to effectively and efficiently be used to receive wireless broadband using over-the-air televisions signals and “spectrum-sensing” technology. Mallard Computer, Inc., is in the process of joining the coalition and petitioning the FCC to clean up the “white space” in the television airwaves.

### SUMMARY OF INVENTION

This device would be used to receive wireless broadband Internet using over-the-air television signals while taking advantage of “spectrum-sensing” technology to effectively connect to the airwaves.

### BRIEF DESCRIPTION OF THE SEVERAL VIEWS OF THE DRAWINGS

Having generally described the invention, reference will now be made to the accompanying drawings, not drawn to specific scale, and wherein:

FIG. 1 illustrates the exterior design of the invention, depicting its front, rear and top views.

FIG. 2 illustrates the exterior design of the portable version of the invention, depicting its side and bottom views.

FIG. 3 illustrates a typical home network operating with this device.

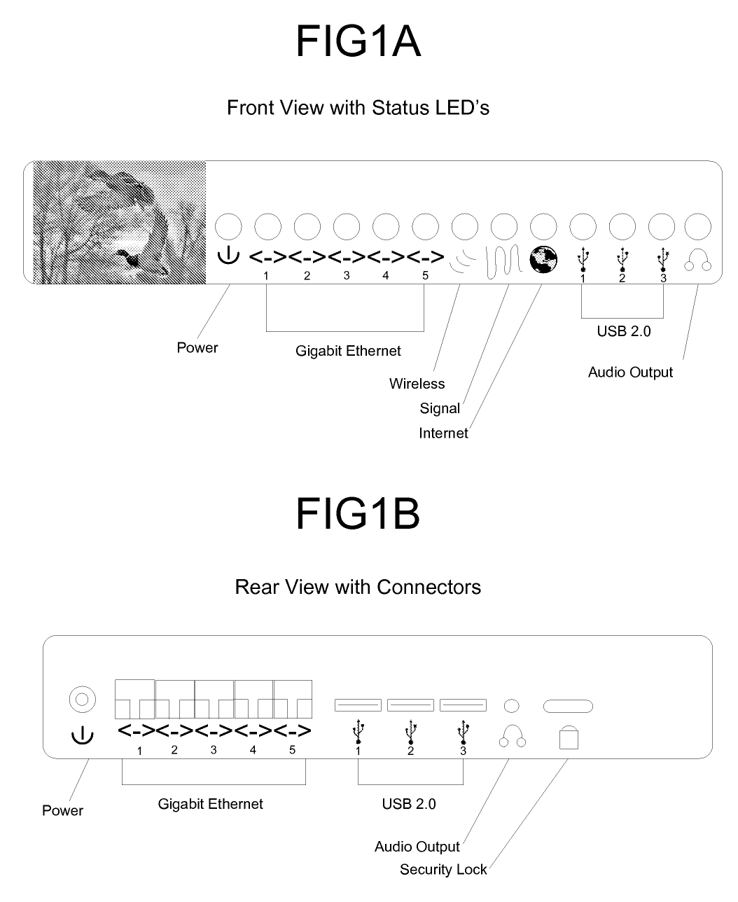

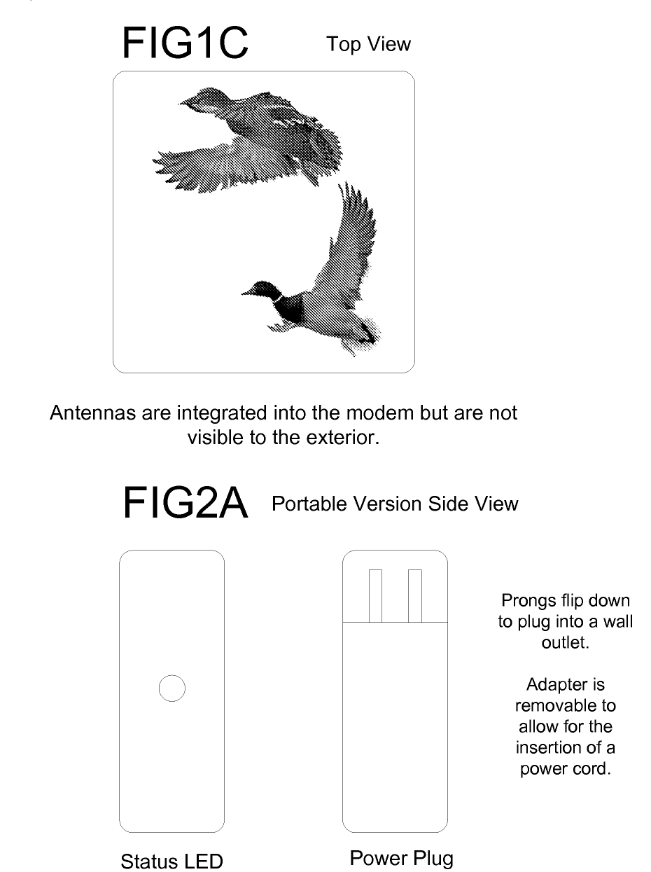

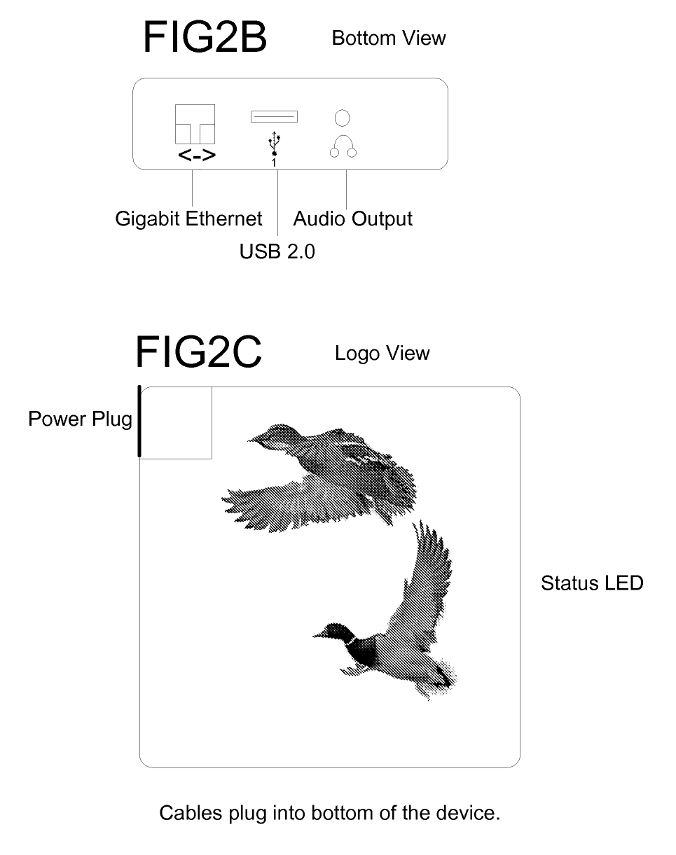

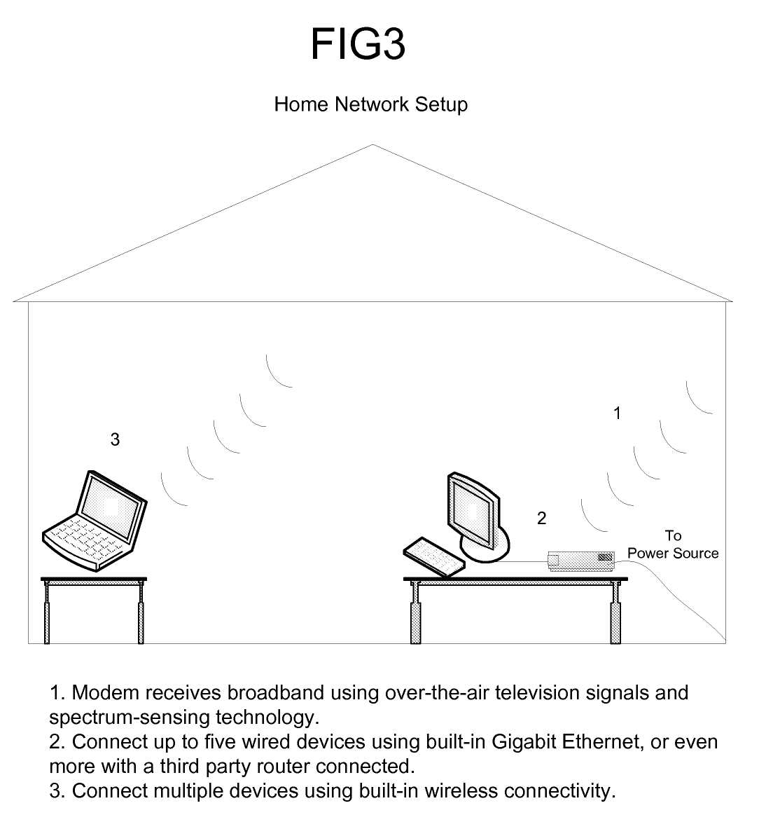

### DETAILED DESCRIPTION OF INVENTION

The invention operates by using a modem designed to receive over-the air broadband signals similar to the way an analog antenna receives over-the-air television signals. However, this invention would not rely on any external or mounted antennas in order to operate. Users will plug the device into a standard wall outlet and the device would immediately begin receiving broadband signals. To make the device easier to plug in, the Alternating Current (AC) power supply would be integrated into the device itself, rather than being supplied through a power brick or AC adapter. This will make the power cable fit into any wall socket with ease.

After the device is plugged in, two functions occur. First, “spectrum-sensing” technology is used to locate the proper frequency on which the modem will operate. Once this has been established, the modem then receives the signals and prepares them to be used for broadband Internet.

In order for personal computers to connect to the Internet using this modem, they will connect to a router integrated into the device using five Gigabit Ethernet ports, 802.11 a/b/g/n/y wireless connectivity, or another form of wireless connectivity proposed by Mallard Computer, Inc. (see related document, “Gigabit Spread-Spectrum Wireless Networking” for more information).

External routers, as well as other Ethernet-compatible devices, may also be connected to the device as well.

In addition to the wireless connectivity and Ethernet ports included in the router, the device also contains three USB 2.0 ports for printer or file-sharing or remote backup, an audio port for streaming music to a stereo or speakers, and a security cable lock to secure to a desk. The USB ports can also be used to stream live weather data from a weather station connected to the device. Users will plug their weather station's data logger into the modem via USB (or serial using a USB to serial adapter), select where they would like to publish their data via the online configuration utility, then the data is automatically streamed to those services 24/7. The device would feature integrated drivers for most popular weather stations brands, including, but not limited to: DAVIS Instruments, AWS/WeatherBug, RainWise, Peet Bros, WeatherHawk, Oregon Scientific, and LaCrosse. Weather station data can be streamed services including, but are not limited to: NWS CWOP (National Weather Service Citizen's Weather Observer Program), Wunderground.com, WeatherForYou, Ambient Weather Exchange Network, WeatherBug Backyard, WeatherBug Professional, School, & Media Network, WeatherLink.com, and a 3^{rd} party web server.

The design of the device will be made out of a teal colored plastic or aluminum exterior that is free of Poly Vinyl Chloride (PVC) and/or plastics regarded as detrimental or unhealthy to individuals and/or the environment. The top view of the device will contain the Mallard Computer, Inc., corporate logo with the backdrop alpha-blended upon the teal coloring. The front view will also contain the Mallard Computer, Inc., corporate logo and also include the trademarked name of the product (Mallard Wi-Net). The front view will also contain a row of Light Emitting Diode (LED) indicators in a circular shape with icons beneath them to identify their function. The LED status indicators are the following: green indicates everything is operating as it should, yellow indicates the presence of an issue that requires attention in order to proceed, and red indicates the modem is not functioning at all. The dimensions of the device are as follows: Length: 6.5 inches (165 mm), Width: 6.5 inches (165 mm), Height: 1.3 inches (34 mm).

Setting up the device is as easy as plugging in a power cord, but users wishing to perform advanced configuration on the device simply have to visit a web application designed to perform the configuration. This simplifies the configuration by having the setup utility run in a web browser instead of creating software that would have to be ported cross-platform, constantly installed and updated. Users needing to perform configuration on a certain computer to access the network can simply go to the Network section of Control Panel (Windows) or System Preferences (Macintosh). Users can download firmware updates through the set-up utility website, or have the firmware updates set to automatically download.

The device employs all of the latest security standards by including an integrated firewall, automatic updating, Wi-Fi Protected Access/Wired Equivalent Privacy (WPA/WEP) encryption, 802.11i and an integrated Virtual Private Network (VPN) client. The device also supports all of the standards to securely connect to web services such as Back to My Mac, screen sharing, remote desktop, remote assistance, and Virtual Network Computing (VNC).

In addition to the desktop version of this device, a mobile version could also be produced that would allow users to setup a network while on the road. In addition, this device could also be used as a wireless repeater to extend the range of the desktop version's (base station) network. The device could also be used to connect to devices that are not in the same room as the desktop base station by using Wireless over Ethernet to connect to those devices. The device would contain one round status LED on the side of the device using the same status LED functions listed above, and contain a power plug on the reverse side that could be swapped out to allow for the insertion of a power cord. The bottom of the device would contain one Gigabit Ethernet port, one USB 2.0 port for file and/or printer sharing and/or weather data streaming, and an audio port for streaming audio across the network. The device would be made out of a teal colored plastic or aluminum exterior that is free from PVC and/or other substances that are harmful to the health of consumers and/or detrimental to the environment. Two sides of the device would contain the Mallard logo alpha-blended upon the teal backdrop. The dimensions for the device are as follows: 3.7 inches (94.01 mm) by 2.95 inches (75.00 mm) by 1.12 inches (28.5 mm).

In addition, the desktop version of the device could also be produced in a version containing an integrated hard drive for remote backup and/or file sharing on the network. The device would look identical to the desktop version device listed above, with the exception that it would be slightly larger in dimensions to accommodate for the integrated hard drive, and contain an additional status LED denoting the status of the hard drive's activity. The hard drive would be connected to the device via Serial Advanced Technology Attachment (SATA) and could be of any capacity. A door on the bottom of the device could be opened via a couple of screws to allow for the removal and/or replacement of the internal drive. The dimensions are as follows: Length: 7.7 inches (197 mm), Width: 7.7 inches (197 mm), Height: 1.4 inches (36.3 mm).

That which is claimed:

1. A spectrum-sensing broadband modem/router that utilizes spectrum-sensing technology to locate the proper frequency on which the device should operate.

2. The frequency-locating method of claim 1 wherein the final spectrum-sensing state selects a vacant candidate signal from available airwaves.

3. The frequency-locating method of claim 1 wherein the final spectrum-sensing state also includes selection of the airwave signal with the least interference.

4. The frequency-locating method of claim 1 wherein the final spectrum-sensing stage includes selection of the strongest available airwave signal.

5. The frequency-locating method of claim 1 wherein, once the proper frequency has been found, the device connects to the television airwaves.

6. The frequency-locating method of claim 1 wherein, once the device has connected to the television airwaves, this device connects wirelessly to broadband Internet data.

7. The connection of claim 6 in which this modem connects to one of five Gigabit Ethernet ports.

8. The connection of claim 6 in which, alternatively, this modem may connect to 802.11 a/b/g/n/y.

9. The connection of claim 6 in which, alternatively, this modem may connect to “Gigabit Spread-Spectrum Wireless Networking.”

10. In addition to the wireless connectivity and five Ethernet ports included in the router, the device will contain three USB 2.0 ports for printer and/or file-sharing or remote backup.

11. In addition to claim 10, the device will include an audio port for streaming music to a stereo or speakers.

12. In addition to claim 11, the device will include a security cable lock to secure the device to a desk.

13. In addition to claim 12, the device will be able to stream live weather data via the USB ports to a weather station connected to the device. Users will plug their weather station's data logger into the modem via USB (or serial using a USB to serial adapter), select where they would like to publish their data via the configuration utility, then the data is automatically streamed to those services 24/7. The device would feature integrated drivers for most popular weather stations brands, including, but not limited to: DAVIS Instruments, AWS/WeatherBug, RainWise, Peet Bros, WeatherHawk, Oregon Scientific, and LaCrosse. Station data can be streamed to services including, but not limited to: NWS CWOP (National Weather Service Citizen's Weather Observer Program), Wunderground.com, WeatherForYou, Ambient Weather Exchange Network, WeatherBug Backyard, WeatherBug Professional, School, & Media Network, WeatherLink.com, and a 3^{rd} party web server.

14. Security standards for the device including an integrated firewall, automatic updating, Wi-Fi Protected Access/Wired Equivalent Privacy (WPA/WEP) encryption (including WPA2, WPA-PSK, and WPA2-PSK), Extensible Authentication Protocol (EAP), Transport Layer Security (TLS), Protected Extensible Authentication Protocol (PEAP), 802.11i, and an integrated Virtual Private Network (VPN) client.

15. The ability to securely connect to web services such as Back to My Mac, screen sharing, remote desktop, remote assistance, and Virtual Network Computing (VNC).

16. The ability to produce a portable version of the modem/router that can be used to create a portable wireless network setup.

17. The ability of this device to be used in conjunction with the larger modem (base station) to extend the network as a wireless repeater.

18. In addition to claim 16 to allow wireless connectivity to devices not located in the same room as the base station using Wireless over Ethernet.

19. The ability to produce a version of the modem/router containing an integrated hard drive for use of wireless backup and file server sharing.
